(19) United States
(12) Patent Application Publication
(10) Pub. No.: US 2019/0130476 A1
(43) Pub. Date: May 2, 2019

(54) Management System and Predictive Modeling Method for Optimal Decision of Cargo Bidding Price

(71) Applicant: Yada Zhu, Yorktown Heights, NY (US)

(72) Inventor: Yada Zhu, Yorktown Heights, NY (US)

(21) Appl. No.: 15/827,740

(22) Filed: Nov. 30, 2017

Related U.S. Application Data
(60) Provisional application No. 62/489,455, filed on Apr. 25, 2017.

(51) Int. Cl. G06Q 30/08; G06N 5/02; G06Q 30/02

(52) U.S. Cl. CPC G06Q 30/08; G06Q 30/0206; G06N 5/02

(57) ABSTRACT

A predictive modeling system and method that improves revenue management for a cargo business, preferably the air cargo business, by bridging a bidding stage and a decision stage by jointly learning dual predictive models, wherein it leverages the intrinsic co-clusters of originations and destinations (OD) to enable information sharing among different OD pairs. The predictive modeling method effectively leverages the block structure of the OD pairs thus increasing revenue.

The present non-provisional application claims priority to the earlier filed provisional application having Ser. No. 62/489,455, filed Apr. 25, 2017, and hereby incorporates subject matter of the provisional application in its entirety.

### BACKGROUND OF THE INVENTION

### (1) Field of the Invention

The present invention relates to a revenue management system and predictive modeling method for obtaining an optimal decision with respect to a cargo bidding price. The invention is a computer-aided decision system for cargo bidding price. The system is architected such that based on various data sources, novel data analytics and optimization methods, optimal bidding price and its associated winning probability, are determined and revenue at different time horizon is maximized.

### (2) Description of the Related Art

Revenue management in the cargo business, especially the air cargo business, is a fast-growing field. It usually consists of two stages: (a) the bidding stage where the vendors provide a bidding price with respect to a pair of origination and destination bidding prices, (referred to hereinafter as “OD pair”) and (b) the decision stage where the customer makes a decision whether to accept this price or not.

There are a number of existing supply chain management, numeric data-mining and economic model systems that relate to pricing optimization in general. These systems have substantial limitations in their application to the specific field of air cargo pricing optimization. The disciplines of Multi-Label learning, Multi-Way Clustering and current systems for Pricing Optimization for Revenue Management, in particular, are sorely limited in their applications to air cargo pricing optimization. These prior-art systems are not pertinent with respect to the present invention, as unlike the present invention, their goal was not to maximize total revenue over a given time horizon.

### Cargo Pricing Optimization Revenue Management

Because the air cargo industry has grown substantially over the past decades, there is a compelling need for a structured environment with the explicit goal of maximizing revenues by offering optimized bidding prices.

Compared to other industries such as passenger airlines or hotels, the air cargo field is more challenging in multiple respects due to the specific characteristics of cargo inventor, cargo business, and cargo booking behavior. This renders traditional yield management models ineffective or inefficient, thus necessitating the development of new models.

Bidding price controls are revenue based and have the advantages of being simple, having a natural interpretation as the marginal value of a given resource, and have a very good revenue performance.

Optimal bidding price methods were introduced and extended by R. Simpson, Using Network Flow Techniques to Find Shadow Price for Market and Seat Inventory Control, MIT Flight Transportation Laboratory Memorandum M89-1, Cambridge, Mass., 1989; and E. Williamson. Airline Network Seat Control, PhD Thesis, MIT, Cambridge, Mass., 1992.

Alleged optimal bidding price methods was also disclosed by B. Smith and C. Penn. Analysis of Alternative Origin-Destination Control Strategies. AGIFORS Annual Symposium Proceedings, 28.

The prior art holistic approach to air cargo optimal bidding price predictions has been unsuccessful for a number of reasons including the following three major challenges.

First, the number of transactions varies significantly among different OD pairs. For those OD pairs whose transaction volume is small, the resulting predictive model tends to be inaccurate due to the lack of training data. Models must be constructed for OD pairs with limited transactions.

Second, existing techniques construct predictive models for the two OD stages separately. The drawback in “separately” is that it prevents key information to be shared by these models. The existing techniques prevent key information to be shared by these models

Third, the originations and destinations can be naturally co-clustered such that the underlying predictive models are similar within each co-cluster.

The framework of the present invention is significantly and substantially different from existing prior art techniques because the prior art addresses the problem of pricing optimization from the holistic perspective mentioned above.

In particular, the present invention bridges the bidding stage and the decision stage by jointly learning the dual predictive models, and it leverages the intrinsic co-clusters of originations and destinations to enable information sharing among different OD pairs. Therefore, unlike the prior art, the present invention is able to improve the performance of both predictive models, which eventually lead to increased revenue.

United States Patent Application Publication Number 2013/0159059A1 discloses systems, methods and software for freight market demand modeling and price optimization, which includes acquiring historical data regarding hauled loads, bid loads (not hauled) and data representative of current and expected conditions and data representing business goals.

The acquired data is mapped to market segments and a demand and price forecast model is generated for each market segment. For each market segment, a pricing element is determined based on the respective market segment model and forecast in view of the business goals.

In the aforementioned invention, the market segmentation and price forecast are separate steps. Price is forecasted by on-demand and weather. The present invention is an integrated framework that jointly segments the origination and destination pair and predicts the price that can maximize the total revenue, i.e. winning probability multiply by price.

United States Patent Publication 2012/0310706 A1 discloses a revenue management system and associated method which is based on demand forecasting used for passenger airlines.

United States Patent Publication 2015/0279217 A1 and U.S. Pat. No. 9,165,471 B 1: discloses systems and methods for determining aircraft payloads to enhance profitability.

These references disclose an aircraft operations system that determines a passenger ticket price, a cargo price and a fuel quantity based on seating capacity, an expected passenger demand, the availability cargo capacity, and an expected cargo demand.

United States Patent Publication 2003/0225593 A1 discloses a revenue management system wherein a method is employed for comparing pricing policies based on dynamic booking and supply conditions.

U.S. Pat. No. 8,321,252 B2 discloses an air cargo yield management system for utilizing booking profiles and unconstrained demand. This reference provides a yield management system in the airline industry to optimize allocating an offered capacity (weight and volume) to different types of requests/categories based on forecasted demand of different categories.

None of the patents cited above disclose cargo pricing optimization based on predicted bidding price and its winning probability.

### 3. SUMMARY OF THE INVENTION

To address the challenges detailed above, the present invention provides via a microprocessor and a method to develop a novel probabilistic framework to simultaneously construct dual predictive models for each OD pair, while uncovering the co-clusters of originations and destinations, a revenue optimization method that maximize the total revenue over a given time horizon, and a capacity forecasting method based on the predicted winning probability.

The instant invention is a system and predictive modeling method specially designed to improve revenue management for the air cargo business. In particular, the predictive modeling method effectively leverages the block structure of the OD pairs to increase revenue

FIG. 1, wherein R^{d} represents real numbers in d dimensions, (i.e., x has d features) and R+ represents positive real numbers, illustrates the present invention wherein revenue optimization management in the air cargo business consists of two stages consisting of: A.) a bidding stage where a vendor, such as, UA, Delta, and/or Air Canada, provides a bidding price with respect to an OD pair sites, and a set of cargo features, that comprise elements such as weight, volume, lead time, market, number of pieces, etc. (As shown in FIG. 1, Features+OD Pair→Price).

Once the price has been determined, B.) the decision stage is implemented wherein air cargo companies use the bidding price provided to them, to accept/reject, (a win/loss situation wherein “accept” is denoted a “win” and “reject” is denoted a “loss”) incoming bookings; i.e., Features+OD Pair+Price→WinRate (decision).

The objective is to maximize REVENUE which is equal to: Σ_{i,j,k} Price_{i,j,k}×WinRate_{i,j,k}.

The decision stage is the time at which the customer makes a decision whether to accept this price or not. Air cargo companies use bidding price to accept/reject incoming bookings: if the rate of the booking is lower than the bidding price value, then the booking is rejected, otherwise it is accepted.

An advantage of the instant invention is that it allows information sharing among all the OD pairs, which significantly boosts the performance of OD pairs having a small transaction volume. The present invention bridges the origin and destination stages by jointly developing and learning the dual predictive models. It also leverages the intrinsic co-clusters of OD pairs to improve the model performance.

The invention is based on the conditional probability of observing the two types of responses from the two OD stages, given the features with respect to the OD pair, and the mappings for co-clustering.

The conventional probability noted, uses an auxiliary distribution that satisfies the co-clustering assumption, and develops a special case of the framework based on generalized linear models.

Multiple correlated models are encapsulated into a single probabilistic framework. In particular, it bridges the bidding stage and the decision stage by jointly learning the dual predictive models, and it leverages the intrinsic co-clusters of originations and destinations to enable information sharing among different OD pairs. The main advantage allows key information to be shared among the different models.

The beneficial result obtained by implementing the present invention provides one with the ability to improve the performance of the predictive model, which eventually leads to increased revenue.

By way of illustration, the co-clusters provide regularization for the dual predictive models, and accurate dual predictive models in turn will improve the performance of co-clustering. It is noted that for the OD pairs with a small transaction volume, such regularization helps alleviate the problem of small training set size.

In the present invention, a customer booking module collects booking information and stores it in a database. An OD pair grouping module groups OD pairs with extreme low transaction volume based on distance and routing information and send developed data to a predictive modeling module. The predictive modeling module queries the booking information and a trained model to simultaneously determine each OD pair's cluster membership and predict their bidding price, win rate and revenue for incoming bookings;

A revenue optimization module takes the outputs from the predictive modeling module, booking information at selected time period, historical data, capacity parameters, and market intelligence factors, etc. and calculates various revenue parameters at different time horizon, such as overall revenue, per OD pair revenue, benchmark overall revenue and benchmark revenue per OD pair.

Output from the revenue optimization module is taken by a capacity forecasting module to forecasting the capacity over selected time period based on total available capacity, existing bookings and predicted win rate of incoming book and determines the capacity availability of selected OD pairs for incoming booking and sends such data back to the revenue optimization module. If the capacity is not sufficient for a selected OD pair, all the incoming booking associated with the OD pair is rejected.

Otherwise, the revenue optimization module compares whether predictive overall revenue exceeds the benchmark overall revenue in a selected time period. If yes, the system recommends to use the predicted bidding price and customer selected route for all incoming bookings; if no, the revenue optimization module identifies OD pairs with predictive revenue less than their corresponding benchmark revenue.

With respect to booking from large, medium and small market sectors, If the predicted price (e.g. P_{L}) is no less than the corresponding threshold (e.g. □_{L}) determined based on customer market sector and market intelligence factor, the system recommends to use the predicted bidding price and route. Otherwise, the revenue optimization module checks whether alternative route for the OD pairs is available. If yes, send the alternative route to the predictive modeling module which performs the bidding price, win rate and revenue prediction given the updated information; if no, the system rejects the incoming booking associated with the OD pair and selected route.

In summary the present invention comprises:
1. A novel probabilistic framework for cargo price optimization, which leverages the intrinsic co-clusters of originations and destinations to construct dual predictive models for all pairs of originations and destinations;
2. a revenue optimization method that selects the optimal route and bidding price that maximizes the revenue for the overall cargo business at different time periods; such optimization method meets the capacity constraint and benchmark revenue per OD pair and overall revenue;
3. a capacity forecasting method that forecasts the capacity, based on total available capacity, booking information and predicted winning probability;
4. an executive reporting module for visualizing the predicted overall revenue, predicted revenue per OD pair, benchmark overall revenue, and benchmark revenue per OD pair over different time period, e.g. yearly, quarterly, monthly or weekly;
5. pricing strategy module that balances multiple decision factors, such as available routes, capacity, peak/off-peak season, customer market category, and market intelligence factor, etc.

While the present invention is primarily directed toward air cargo optimization, it is understood that the invention can be applied to any cargo pricing optimization, land or air.

### BRIEF DESCRIPTION OF THE SEVERAL VIEWS OF THE DRAWINGS

FIG. 1 depicts the bidding and decision stages of revenue management in the air cargo business.

FIG. 2 illustrates the general approach to the predictive modeling method of the present invention.

FIG. 3 is a flowchart illustrating the architecture and steps of the present invention.

FIG. 4 contains bar graphs illustrating how bidding price is affected by the difference in cargo volume and customer size.

FIG. 5 illustrates how the present invention consistently outperforms as-is method.

FIG. 6 illustrates how the present invention leads to higher expected revenue than as-is method.

FIG. 7 discloses three system modules for three type of end users of the present invention.

FIG. 8 discloses executive reporting module that facilitates the cargo pricing decision with respect to revenue maximization.

FIG. 9 discloses pricing strategy module that facilitates iteratively determining the optimal route and bidding price given season, market, capacity and customer category.

FIG. 10 discloses booking interface for customers and for data collecting

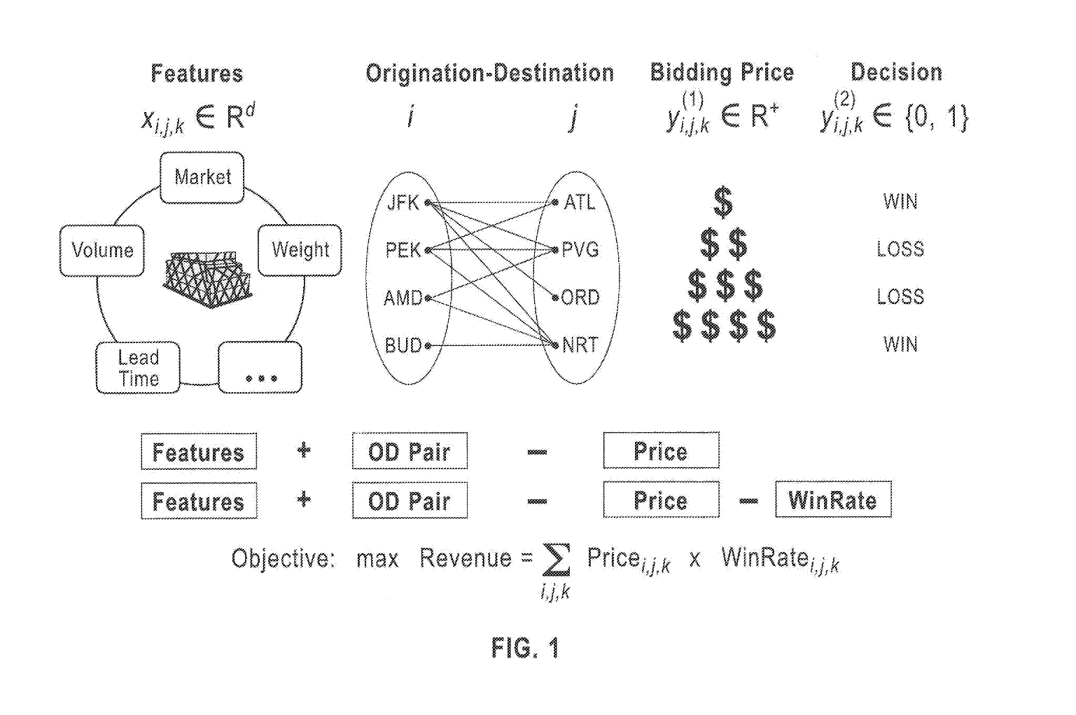

### DETAILED DESCRIPTION OF THE INVENTION

### A Probabilistic Framework

To address the problems described above, a probabilistic framework has been developed to simultaneously construct dual predictive models and uncover the co-clusters of originations and destinations. This approach maximizes the conditional probability of observing the responses from both the quotation stage and the decision stage, given the features and the co-clusters, By introducing an auxiliary distribution based on the co-clustering assumption, such conditional probability can be converted into an objective function.

To minimize the objective function, any method is utilized, which will generate both the suite of predictive models for all the pairs of originations and destinations, as well as the co-clusters consisting of similar pairs.

The probabilistic framework of the present invention includes an objective function, as set forth in detail below. The function includes co-clustering of OD pairs and dual prediction, as set forth below. The objective function can be solved iteratively by maximizing the one block of the objective function while concurrently keeping the others constant. This exercise is performed alternatively until the decision variables do not change or the change is less than a given tolerance.

The following expression discloses the objective function used to determine the conditional probability of observing the data, i.e., the two types of responses and vectors of the parameters given the features Xᵢⱼₖ and the mappings Φ_{R} and Φ_{C} by modeling bidding price using the linear regression model and concurrently modeling win rate using the linear regression and logistic regression model.

Σ_{i,j,k} {log p (y_{i,j,k}⁽¹⁾|x_{i,j,k}, β_{i,j}⁽¹⁾)+log p (y_{i,j,k}⁽²⁾|x_{i,j,k}, y_{i,j,k}⁽¹⁾, β_{i,j}⁽²⁾)}+Σₛ (Σ_{r,c} log μ_{i,j}^{(s)}p(ûᵣ, \hat{v}_{c}))+Σᵣ Σ_{Φ}_{_{R}}₍ᵤ_{ᵢ}_{)=û}_{ᵣ} log p^{(s)} (uᵢ|ûᵣ) p^{(s)} (β_{i,j}^{(s)}|uᵢ)+cΦ Cvj=vc log psvj|vcp [symbol] i,j(s)|vj

where the first term is the log likelihood of the model to predict the bidding price based on cargo information x_{i,j,k}, and i, j, and k represent original i, destination j, and the kth cargo, a linear regression model can be used, and β_{i,j}⁽¹⁾ is the coefficient matrix to be estimated. The second term is the log likelihood of model to predict the win rate based on both cargo features and bidding) price y_{i,j,k}⁽¹⁾, a logistic regression model can be used, β_{i,j}⁽²⁾ is the coefficient matrix to be estimated. The third term is the joint probability of the rth row and cth column cluster and imposes the assumption that the coefficient matrix of the two models share the same co-cluster membership, where μ_{i,j}^{(s)} is a normalized parameter such that p(ûᵣ, \hat{v}_{c}), is a meaningful probability distribution. The fourth term is the log likelihood of the probability given the ith origination, and the fifth term is the log likelihood of the probability given the jth origination.

The results of a winning probability after co-clustering in accordance with the present invention is illustrated by the clear difference in bidding price which can be interpreted by the difference in three important features consisting of lead time, cargo volume and customer size.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flow chart illustrations and/or block diagrams, can be implemented by computer readable instructions.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in reverse order, depending upon the functionality involved. It will also be noted that each block of the block diagrams and/or flowchart illustration, can be implemented by special purpose hardware-based systems that perform the specified functions or acts or carry out combinations of special purpose hardware and computer instructions.

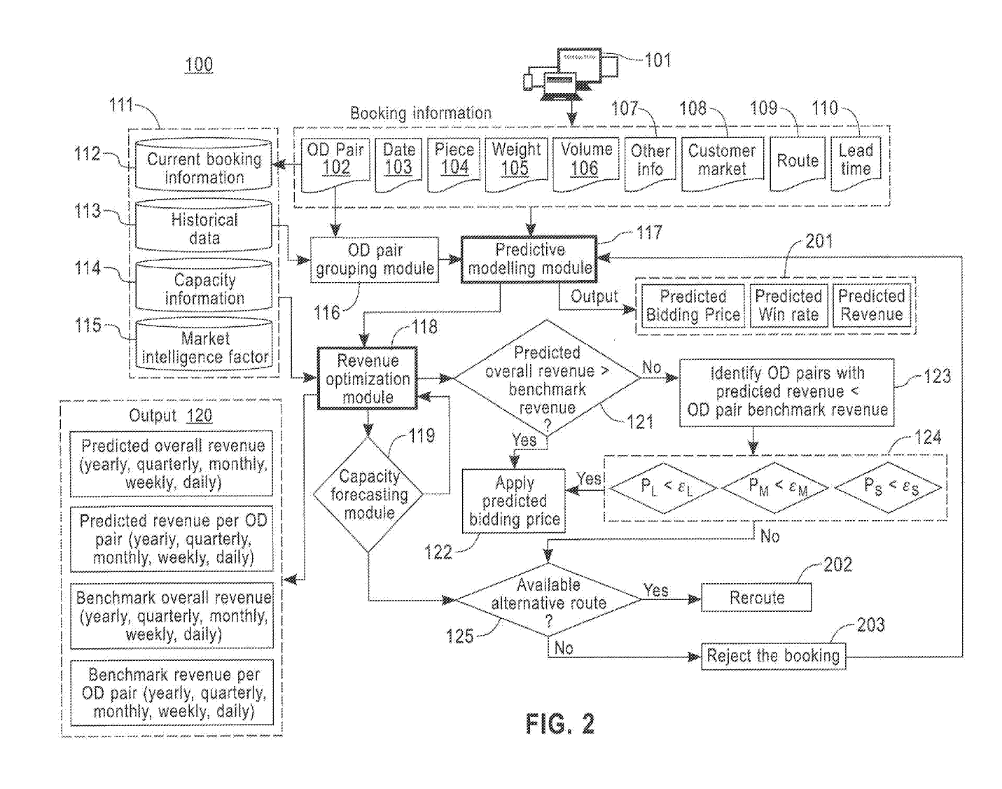

FIG. 2 details the predictive modeling method with its probabilistic framework having an output that includes predicted bidding price, predicted win rate and predicted revenue. Using co-clusters of OD pairs in combination with dual prediction, one simultaneously constructs dual predictive models by modeling bidding price using a linear regression model and concurrently modeling win rate using a logistics regression model.

Co-clustering the OD pairs based upon the coefficient of predictive models is effected such that the predictive models are similar within the same co-cluster to enhance information sharing.

As shown in FIG. 2, the co-clustering is regularized so that the block structure is shared across the dual prediction so that it bridges the bidding stage and the decision stage by jointly learning the dual predictive models.

Based upon the regularization and information sharing, the dual prediction supplies the bidding price and thence the win rate.

The method used in the present invention provides a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

The present invention also relates to an apparatus for performing these operations. This apparatus may be specially constructed for the required purposes or it may comprise a micro-processor or general purpose computer as selectively activated or reconfigured by the computer program stored in the computer. The operations described herein which form part of the present invention are machine operations.

The required structure for a variety of these machines will appear from the description given below. In all cases, there should be borne in mind the distinction between the method operations in operating a computer and the method of computation itself.

Co-clustering, as used in the present invention is a data mining technique which allows simultaneous clustering of the rows and columns of a matrix. Given a set of m rows in n columns (i.e., an m×n matrix), the algorithm used herein generates co-clusters—a subset of rows which exhibit similar behavior across a subset of columns, or a subset of columns which exhibit similar behavior across a subset of rows. “Co-clustering” is regarded as a pair of maps from rows to row-clusters and from columns to column-clusters.

The major difference between existing methods for multiway clustering and the present invention is that from the perspective of the present invention its inputs of co-clustering are the dual predictive models for both the bidding stage and the decision stage, and a goal of the present invention is to jointly infer the mappings for co-clustering as well as the dual predictive models.

The OD pairs present a block structure, i.e., co-clusters. It has been determined that OD pairs with limited transactions can borrow information from others within the same block which can improve the prediction of price and the win rate.

In implementing the present invention, given the features associated with a pair of origination and destination, it is necessary to simultaneously predict both the optimal price for the bid stage and the outcome of the transaction (win rate) in the decision stage.

A further consideration is that is often the case that the matrix representing pairs of originations (O) and destinations (D) has a block structure, i.e., the originations and destinations can be co-clustered such that the predictive models are similar within the same co-cluster, and exhibit significant variation among different co-clusters.

It is necessary to uncover the co-clusters of originations and destinations while constructing the dual predictive models for the two stages.

A probabilistic framework is employed to simultaneously construct dual predictive models, and uncover the co-clusters of originations and destinations, followed by the introduction of the microprocessor programmed to carry out the algorithm for solving the optimization problem.

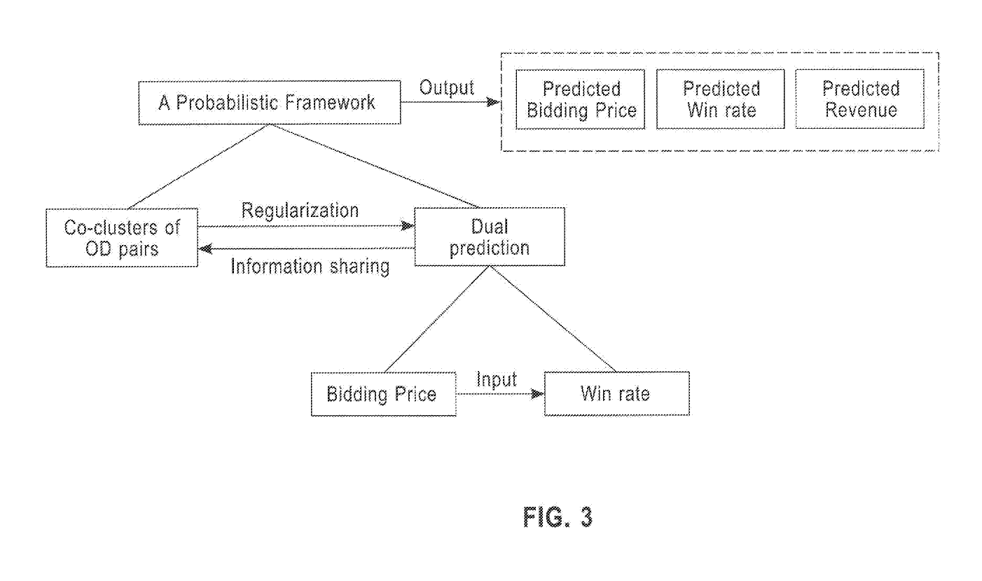

FIG. 3 presents an overview of the process of the present invention using a flowchart diagram.

Referring to FIG. 3, the flowchart defining the system and method of the present invention 100 comprises a User Interface 101. User Interface 101 displays cargo booking information that includes, but is not limited to, cargo features such as weight, volume, number of pieces, lead time and market all associated with origination and destination. User Interface 101 displays the predicted cargo price, winning probability and revenue information. The predicted cargo price, winning probability and revenue information all displayed on User Interface 101 are the result of the process illustrated in flow chart 100.

The first step in the process of the cargo pricing optimization of the present invention commences by gathering Booking Information 200 comprising diverse variables such as the OD pairs 102, the data 103, the piece 104, the weight 105, the volume 106, customer market 108, route 109, lead time 110 and other information 107 and assembling them in a cargo Booking Information element 112 (See FIG. 13 wherein a document depicting an actual Booking Interface Pricing Strategy as it appears on a microprocessor monitor screen lists the shipping requirements input that are loaded onto the microprocessor hard drive to be processed.) Data comprising the variables noted above are collected, stored and queried in a Current Booking Information module 112 in Data Center 112. Elements comprising Data Center 111 consist of Current Booking Information 112, Historical Data 113, Capacity Information 114 and Market Intelligence Information 115.

Data Center 111 is a functional block that stores users' input, system output, the historical data, capacity information, routing, and marketing intelligence factors as well as the current booking information noted above.

Data Center 111 not only contains current booking information as depicted, but also contains historical data for the OD pairs. Historical Data 113 in Data Center 111 includes, but is not limited to, historical cargo booking information associated with OD pair, corresponding bidding price and outcome.

In the process, OD Pair 102 transmits data to Current Booking Information 112. In addition, OD pair 102 sends data to OD Pair Grouping Module 116 concurrently with data from Historical Data 113.

As depicted in FIG. 3, variables comprising Booking Information 200 and the collected data in the OD Pair Grouping Module 116 are sent to Predictive Modeling Module 117.

Historical data 113 and data from OD pair 102 in Booking Information 200 are both fed to the OD Pair Grouping module 116 which groups the OD pairs with extreme low transaction volume based on distance and routing information. For example, Westchester N.Y. airport can be grouped with JFK in NY.

Historical data 113 in Data Center 111 and OD Pair 102 data in Booking Information 200 that have been sent to OD Pair Grouping Module are both sent to Predictive Modeling Module 117 and queried therein.

Predictive Modeling Module 117 is a functional block that trains the predictive models, updates the predictive models and generates the output based upon the booking information or the adjusted booking information.

Predictive Modeling Module 117 processes data received from OD Pair Grouping 116, Booking Information 200 and rerouted data from decisions made later in the process.

Outputs emanating from Predictive Modeling Module 117 are: a.) a predicted cargo price given the booking information associated with a given OD pair (Predicted Bidding Price); b.) a predicted win rate (i.e., a winning probability) of the predicted cargo price (Predicted Win Rate); c.) expected revenue from the predicted price and win rate (Predicted Revenue).

Another output from Predictive Modeling Module 117 is processed data directed to Revenue Optimization Module 118.

Revenue Optimization Module 118 is a functional block that calculates the revenue at a different level at a difference time period and optimizes the decision for utilization of the predicted bidding price.

After a transaction is executed, there are three distinct data segments emanating from the Revenue Optimization Module 118 consisting of a Capacity Forecasting Module 119, an Output 120 and a series of decisions, one of which may be rerouted to the Predictive Modeling Module 117.

A first data result is the Output 120 from Revenue Optimization Module 118 which consists of revenue calculation for the overall cargo business at different time period and revenue calculation with respect to each OD pair at a different time period.

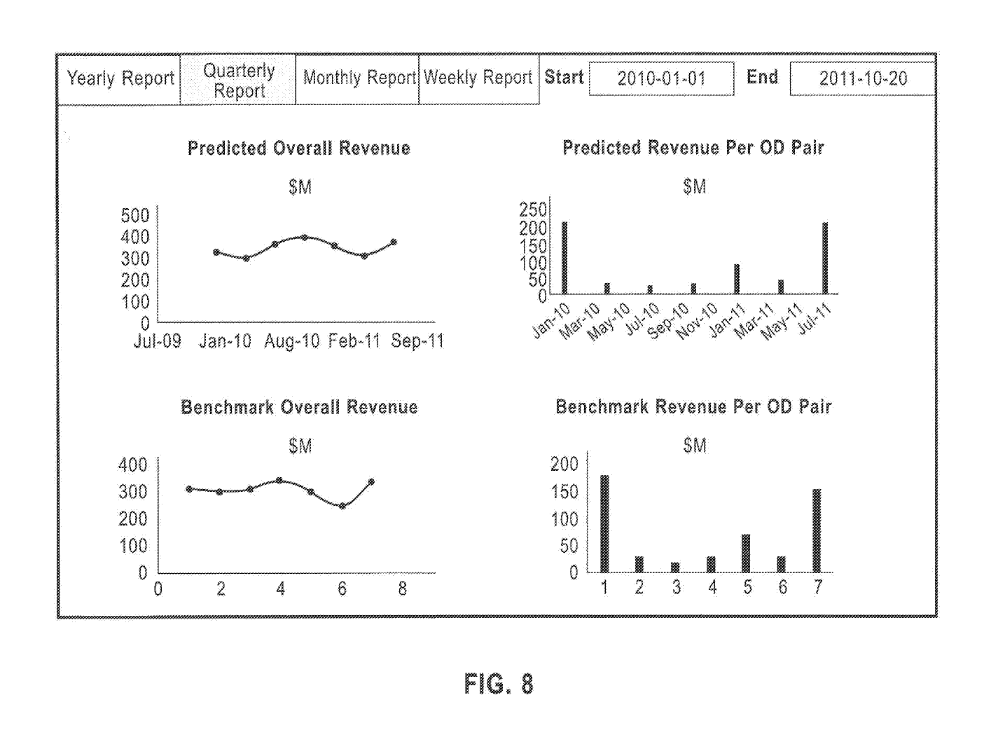

More specifically, Revenue Optimization Module 118 produces Output 120 that predicts overall revenue (yearly, quarterly, monthly weekly, daily), predicted revenue per OD pair overall revenue (yearly, quarterly, monthly weekly, daily), benchmark overall revenue (yearly, quarterly, monthly weekly, daily) and benchmark revenue per OD pair (yearly, quarterly, monthly weekly, daily). Examples of this Output is illustrated in the graphs presented in FIG. 8.

As for the second data result, in addition to providing data to Output Module 120, Revenue Optimization Module 118 sends selected data to Capacity Forecasting Module 119 which forecasts the capacity based on total available capacity, booking information and predicted win rate. Certain data that needs to be reassessed in Capacity Forecasting Module 119 will be returned to the Revenue Optimization Module 118 for further processing.

Other data in Capacity Forecasting Module 119 is transmitted to Available Alternative Route 125.

With respect to the third data result, Revenue Optimization Module 118 processes data to make an alternative series of operations and complex decisions by assessing whether Predicted Overall Revenue is greater than the Benchmark Revenue at decision 121; if Yes, the processed data from Revenue Optimization Module 118 is applied to the predicted bidding price 122; if No, the system identifies OD pairs with predicted revenue less than the OD pair benchmark revenue at 123.

The OD pairs with predicted revenue less than the OD pair benchmark revenue are selected from pairs indicated in FIG. 3, option 124 identified for large customer sector as (P_{L}>ε_{L}), medium customer sector as (P_{M}>ε_{M}) and small customer sector as (P_{S}>ε_{S}). Where P and ε are predicted revenue and OD pair benchmark revenue, respectively, L M and S indicate the customer market size.

If Yes, an OD pair does exist with predicted revenue less than the calculated OD pair benchmark revenue, the data is forwarded to the process of applying Predicted Bidding Price 122; If No, the selected OD small, medium and large pairs are forwarded to decision object Available Alternative Route 125 wherein a Yes reroutes the data to Predictive Modeling Module 117 for a reassessment; if No, the data from Capacity Forecasting Module 119 and operations at 123 and 124 are rejected and such data is returned to the operation of applying the Predicted Bidding Price 117.

At the end of the data processing on the microprocessor, the predicted cargo price, winning probability and revenue information are displayed.

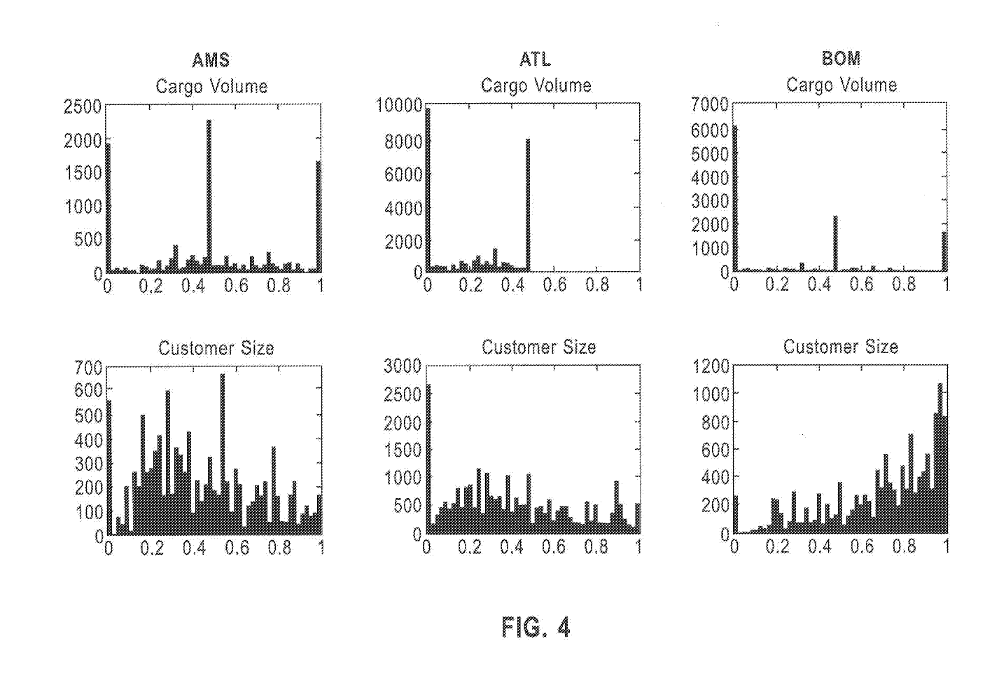

FIG. 4 graphically indicates the customer size as related to airports located in Europe (AMS), the United States (ATL) and Asia (BOM) respectively, and for each, plots the distribution of bidding price as a function of customer size.

FIG. 4 also graphically illustrates the cargo volume associated with the three airports noted above and plots the distribution of bidding price as a function of cargo volume. The three airports noted in FIG. 4 are situated in three distinct row clusters with other airports in each row that are similarly situated geographically. Thus, the three airports are an example from each of the three row clusters respectively. The three rows clusters present a strong difference in the average bidding price. The price distinction is explained by the difference in three critical features: customer size, cargo volume and lead time (not shown).

As shown in FIG. 4, the cargo volume of AMS is about half that of ATL and BOM. The customer size of BOM is relatively large compared with ATL and AMS. Based on this data, one can conclude that large customer size and cargo volume lead to high bidding prices and vice versa. The three column clusters presented similar patterns.

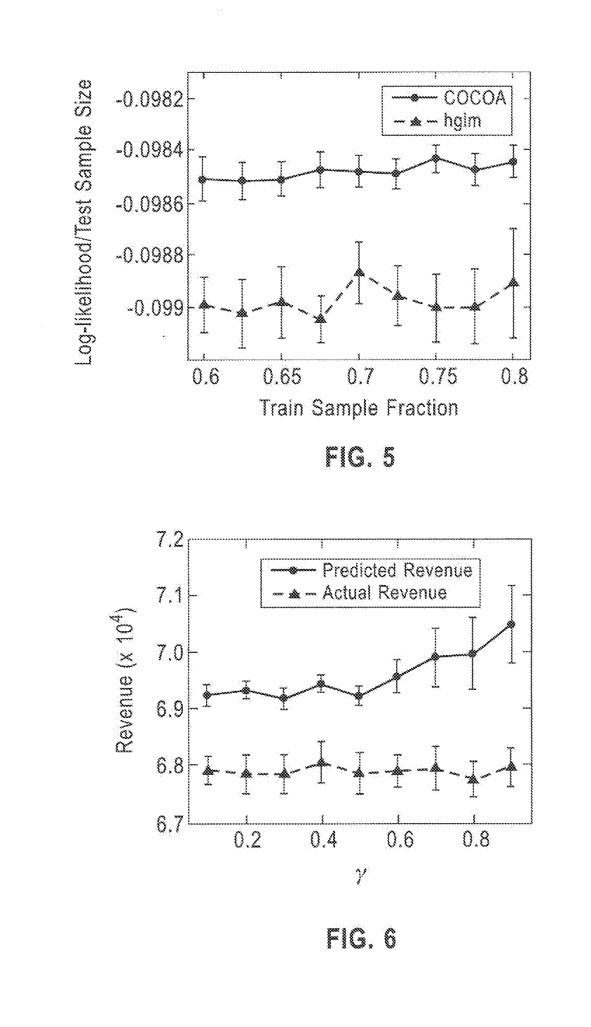

FIG. 5 presents a comparison between the use of the present invention and hglm (described in detail hereinafter) based on the real data set in terms of total log likelihood of price and win probability. In FIG. 5, the X-axis is the fraction of transactions per OD pair used for training, and the Y-axis is the total log likelihood of price and win probability prediction normalized by test sample size.

For each training sample fraction, the experiment was repeated 20 times and the mean and standard deviation of the normalized log likelihood as an error bar plot was reported.

FIG. 5 shows that the present invention obtains not only larger mean log likelihood value but also smaller variation of log likelihood value than hglm over all training sample fractions. The present invention outperforms hglm because it leverages the block structure in the prediction stages of both price and win probability. In reality, the objective function can be extended to include a weight on the price prediction and win probability prediction to reflect one's preference.

FIG. 6 depicts the impact of γ on the price optimization. FIG. 6 plots the X axis which is γ, a range of win probability and values as a function of the Y axis which is revenue. The graph confirms that the use of the present invention improves revenue significantly by its superior performance.

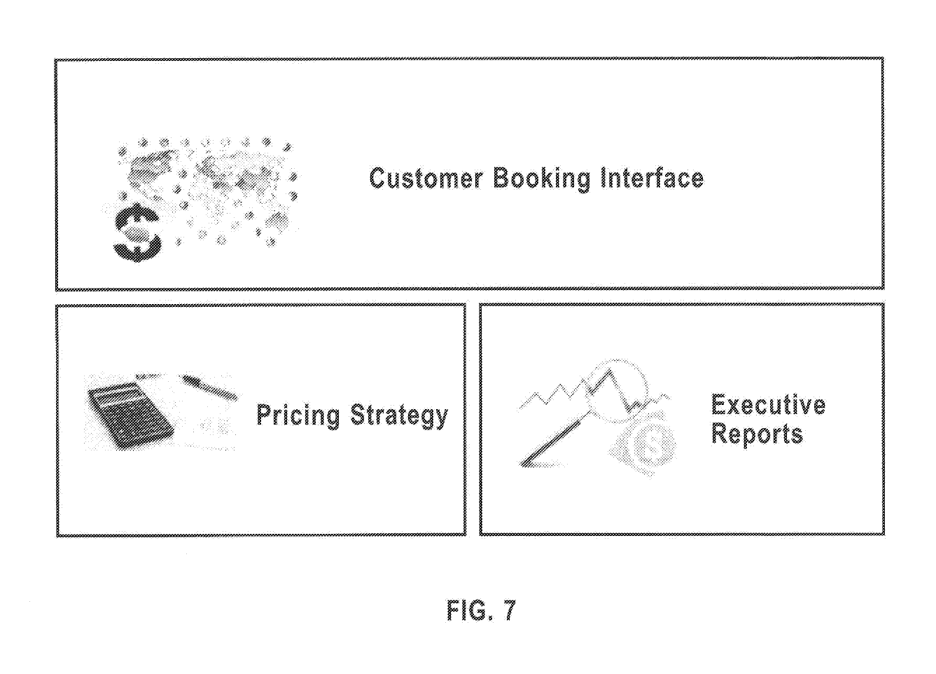

FIGS. 7 through 10 relate to features of the present invention that are associated with the end users. FIG. 7 details the features depicted in FIGS. 8 through 10, namely customer booking interface, pricing strategy and executive reports.

### Executive Reports

FIG. 8 is a booking interface that assembles the preliminary data including shipping requirements, cargo information and contact information necessary to practice the present invention.

FIG. 8 is an illustrative print-out of an Executive report from a microprocessor monitor showing a Quarterly Report for a given time period that discloses information obtained from Output 120 (depicted in FIG. 3, in readable form). Information depicted on the FIG. 8 form is Predicted Overall Revenue (top) compared with Benchmark Overall Revenue, and Predicted Revenue Per OD Pair compared with Benchmark Revenue Per OD Pair.

### Pricing Strategy

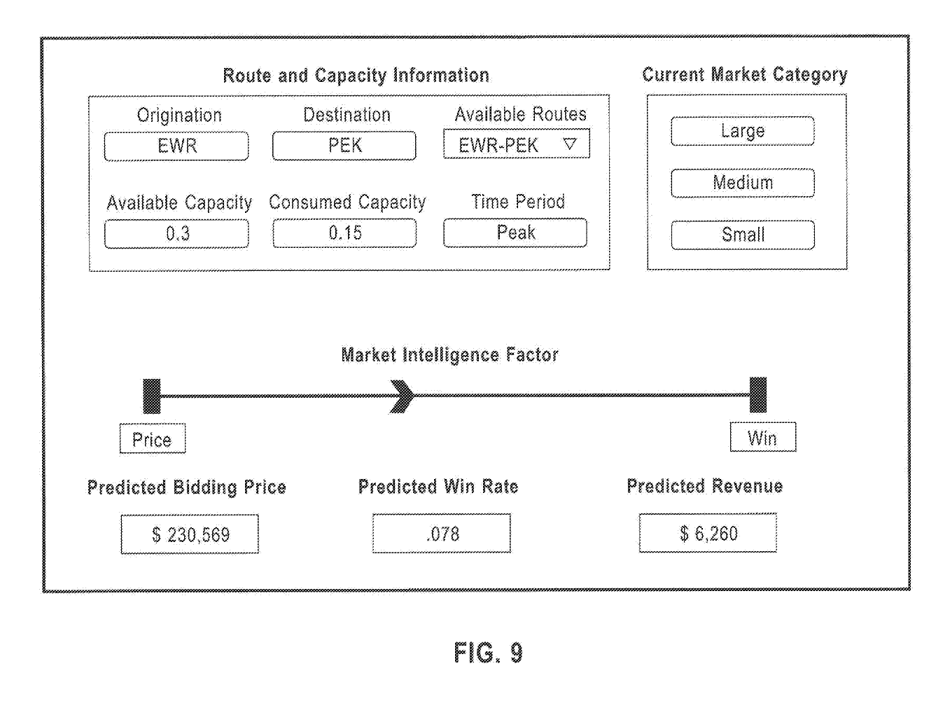

FIG. 9 is an illustrative print-out of an Executive report from a microprocessor monitor showing variables in Booking Information 200 (in FIG. 3) that are used in pricing strategy. As shown in FIG. 9, the read-out disclosure from the perspective of Capacity Information includes Route and Capacity Information comprising Origination, Destination, Available Routes, Available Capacity, Consumed Capacity and Time Period. Further disclosed is a Customer Market Category comprising Large Medium and Small routes.

From the perspective of Market Intelligence Factor, the disclosure shows a variable result between Price and Win along with results establishing a Predicted Bidding Price, a Predicted Win Rate and Predicted Revenue.

### Booking Interface

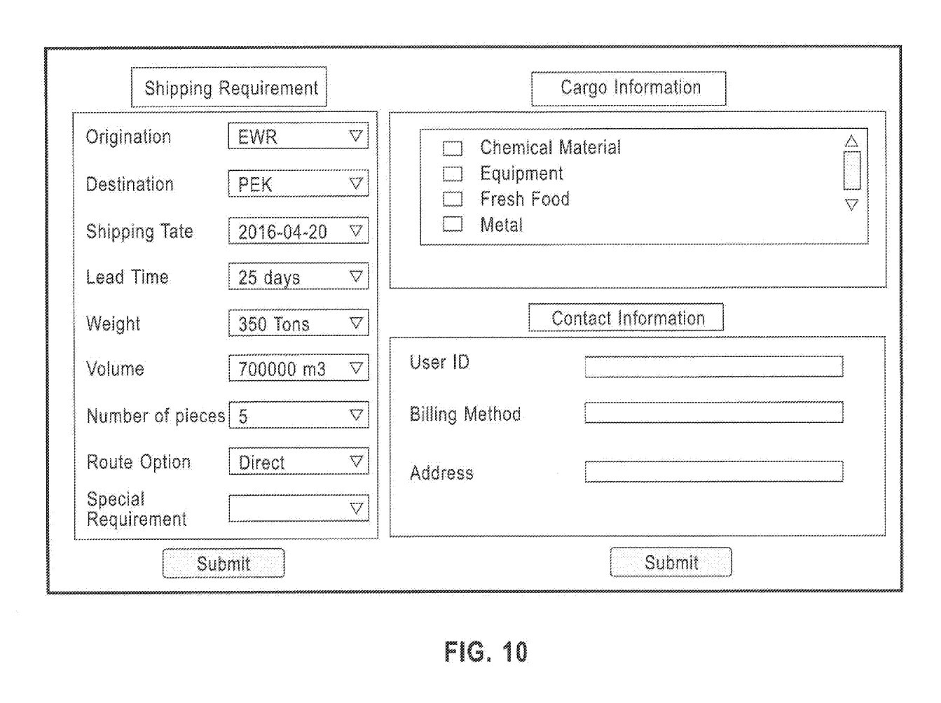

FIG. 10 is an illustration of a page uploaded onto the monitor of a microprocessor that supplies information used in submissions to the Data Center. The first submission provides Shipping Requirement information which comprises the OD pairs, shipping date, lead time, weight, volume, number of pieces, route option and special requirements, if any.

Another submission is listed as Cargo Information, which is the nature of the product being shipped and Contact Information for the use of the parties to the transaction.

The data defined in FIGS. 8-10 all emanate from the method shown in FIG. 3.

### EXAMPLE

### Predictive Modeling

The algorithm used in accordance with the present invention provides for co-clustering based dual prediction framework. The prior art challenges noted above are overcome by integrating a regularized linear sub-model for the bid price prediction and a generalized linear sub-model for the win-rate prediction in a consistent framework.

The performance of the invention was tested in a real cargo pricing optimization problem. Twenty originations and 20 destinations with arrange of high-low volume of transactions were selected. Among the resulting 400 OD pairs, about 25% of them had less than 20 transactions. The OD pairs with less than 20 transactions were excluded from training, which was estimated based on its cluster membership's average, etc.

Each transaction was accompanied with historical bidding' prices and bidding stages (win or loss) and several other features, including number of cargo pieces, cargo weight, cargo volume, lead time and customer size, etc. Based on domain knowledge and the initial study, R (row) and C (column) were set=3. In the process. β_{i,:}^{(s)} and β_{:,j}^{(s)} were initialized as 0. Cluster members were randomly generated. To make a fair comparison between the present invention and as-is method for this investigation, as-is method was also given the same number of row/clusters, i.e., R=C.

In accordance with the present invention, using the algorithm disclosed above a modeling bidding price was obtained using a linear regression model, and a modeling win rate was obtained using a logistic linear regression model.

To establish conclusively the present invention's advance in the art, it was determined to be appropriate to compare its performance with an existing advanced hierarchical clustering and prediction methodology, The as-is method is named as the Hierarchical Logistic Regression Model (hglm) is an advanced hierarchical clustering and prediction methodology framework currently adopted by a worldwide cargo company.

Hglm is different from the algorithm used in accordance with the present invention, as hglm performs co-clustering and prediction separately.

In addition, the hglm two-step method tends to introduce extra variances by using outputs from the first step model as inputs for the second model. In addition, there is no adaptive feedback process to improve the performance for both models.

To make a fair comparison, hglm was also given the same number of row/column clusters R=C as is used in the present invention algorithm. The evaluation of the present invention in terms of the co-clustering results, predictive likelihood, improvement of revenue, and convergence rate is presented hereinafter.

It is noted that the hglm system has a natural hierarchical structure, e.g., different transactions are grouped to different OD pairs. The first step of the frame-work is to cluster OD pairs based on the win rate effects directly coming from the OD pairs and use the following Hierarchical Logistic Regression Model to estimate such effect.

Log it {E (yᵢⱼₖ)}=Xᵢⱼₖ βᵢⱼ+Zᵢⱼ uᵢⱼ+εᵢⱼₖ

where yᵢⱼₖ is the k^{th} cargo-price bidding stage (win or loss) for the i^{th} origination and the j^{th} destination; Xᵢⱼₖ be the corresponding fixed effects which include bidding specific variables and customer market information. Zᵢⱼ represents the random effects coming from the OD (origination and destination) pair (i;j); βᵢⱼ is the coefficient for the fixed effects and uᵢⱼ is OD pair (i;j) effect estimation and εᵢⱼₖ is the error term.

In a hierarchical model, observations are grouped into clusters (e.g., origination-destination in this cargo-price bidding problem), and the distribution of an observation is determined not only by the common structure among all clusters but also by the specific structure of the cluster where this observation belongs to. So the random effect component, different for different clusters, is introduced into the model.

In the second step, the cargo company using hglm co-clusters the OD pairs based on the homogeneous effects for the win rates that are estimated through a model. Each cell of the matrix is the random effect estimation of a specific OD pair. The basic idea of co-clustering consists in making permutations of objects and variables in order to draw a correspondence structure (e.g., pattern recognition) for the most similar effects.

The density for each block is given by

$${f}_{kl} ( {u}_{i , j} \text{:} α ) = \frac{1}{\sqrt{2 {πσ}_{kl}^{2}}} exp \{ - \frac{1}{2 {σ}_{kl}^{2}} {( {u}_{ij} - {u}_{kl} )}^{2} \}$$

Where uᵢⱼ is OD pair effect for origination i and destination j and α=(u_{i,j}, σₖₗ²) is the cluster specific mean and variance.

However, the hglm two-step method introduces extra variances from estimating the first framework and using the out-puts as inputs for the second modeling. Also, there is no adaptive feedback process to improve the performance for both models.

This two-step method has had some success in helping the cargo company using hglm to develop an automatic optimized pricing machinery to increase revenue.

However, it is emphasized that this two-step method did not bridge the information sharing and connection among the two modeling.

The present invention as detailed above, addresses the heretofore unsolved problem of cargo pricing optimization, more specifically, air cargo pricing optimization. The invention discloses a probabilistic framework to maximize the conditional probability of observing two types of responses from the two stages (the bidding stage and the decision stage) given the features for each OD pair and the mappings for co-clustering. Compared with existing prior art, the advantages of the framework described are three-fold.

First of all, the present invention allows information sharing among all the OD pairs, which significantly boosts the performance on the OD pairs with a small transaction volume.

Second, it bridges the two stages by jointly learning the dual predictive models. Finally, it leverages the intrinsic co-clusters of originations and destinations to improve the model performance.

Furthermore, the framework was instantiated with both an auxiliary distribution designed based on the co-clustering assumption, and generalized linear models for the two types of responses. Also, an iterative algorithm was implemented for solving the resulting optimization problem in an effective and efficient manner.

The present invention comprises a conventional computer system which contains a set of instructions, for causing the machine to execute and perform any one or more of the methodologies and operations discussed herein, as a result of being programmed to perform particular functions pursuant to the instructions. The computer system per se includes a bus or other communication mechanism for communicating information, and a processor or processors coupled with bus for processing information.

The computer system also includes a main memory, such as a random-access memory (RAM) or other dynamic storage device, coupled to bus for storing information and instructions to be executed by processor. Main memory also may be used for storing temporary variables or other intermediate information during execution of instructions to be executed by processor 404. Computer system further includes a read only memory (ROM) or other static storage device coupled to bus for storing static information and instructions for processor.

A storage device such as a magnetic disk or optical disk, is provided and coupled to bus for storing information and instructions.

The computer system may be coupled via bus to a display, such as a cathode ray tube (CRT), for displaying information to a computer user. An input device, including alphanumeric and other keys, is coupled to bus for communicating information and command selections to processor.

Another type of user input device is cursor control such as a mouse, a trackball, or cursor direction keys for communicating direction information and command selections to processor and for controlling cursor movement on display. This input device typically has two degrees of freedom in two axes, a first axis (e.g., x) and a second axis (e.g., y), that allows the device to specify positions in a plane.

The computer system is used to process an algorithm, using equations and principles discussed herein, into usable data.

The instructions may be provided in any number of forms such as source code, assembly code, object code, machine language, compressed or encrypted versions of the foregoing, and any and all equivalents thereof.

“Computer-readable medium” refers to any medium that participates in providing instructions to processor for execution and “program product” refers to such a computer-readable medium bearing a computer-executable program. The computer usable medium may be referred to as “bearing” the instructions, which encompass all ways in which instructions are associated with a computer usable medium.

Computer-readable mediums include, but are not limited to, non-volatile media, volatile media, and transmission media. Non-volatile media include, for example, optical or magnetic disks, such as storage device.

Volatile media include dynamic memory, such as main memory 406. Transmission media include coaxial cables, copper wire and fiber optics, including the wires that comprise bus. Transmission media may comprise acoustic or light waves, such as those generated during radio frequency (RF) and infrared (IR) data communications.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor for execution. For example, the instructions may initially be borne on a magnetic disk of a remote computer.

The remote computer can load the instructions into its dynamic memory and send the instructions over a telephone line using a modem. A modem local to computer system can receive the data on the telephone line and use an infrared transmitter to convert the data to an infrared signal. An infrared detector coupled to a bus can receive the data carried in the infrared signal and place the data on bus. Bus carries the data to main memory, from which processor retrieves and executes the instructions. The instructions received by main memory may optionally be stored on storage device either before or after execution by processor.

Computer system may also include a communication interface coupled to bus to provide a two-way data communication coupling to a network link connected to a local network.

For example, communication interface may be an integrated services digital network (ISDN) card or a modem to provide a data communication connection to a corresponding type of telephone line. As another example, communication interface may be a local area network (LAN) card to provide a data communication connection to a compatible LAN. Wireless links may also be implemented. In any such implementation, communication interface sends and receives electrical, electromagnetic or optical signals that carry digital data streams representing various types of information.

Network link typically provides data communication through one or more networks to other data devices. For example, network link may provide a connection through local network to a host computer or to data equipment operated by an Internet Service Provider (ISP).

ISP in turn provides data communication services through the worldwide packet data communication network, now commonly referred to as the “Internet.” Local network and Internet both use electrical, electromagnetic or optical signals that carry digital data streams.

The signals through the various networks and the signals on network link and through communication interface, which carry the digital data to and from computer system, are exemplary forms of carrier waves transporting the information.

Thus, the processing required by methods of the invention described by way of example herein may be implemented on a local computer utilizing storage device or may be implemented, for example, on a LAN or over the internet.

Computer system can send messages and receive data, including program code, through the network(s), network link, and communication interface. In the Internet example, a server might transmit a requested code for an application program through Internet, ISP, local network and communication interface.

The received code may be executed by processor as it is received, and/or stored in storage device, or other non-volatile storage for later execution. In this manner, computer system may obtain application code in the form of a carrier wave.

Various embodiments disclosed herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to the provided description without departing from the scope or spirit of the disclosure.

Other embodiments, uses and features of the present disclosure will be apparent to those skilled in the art from consideration of the specification and practice of the inventive concepts disclosed herein. The specification and drawings should be considered exemplary only, and the scope of the disclosure is accordingly intended to be limited only by the following claims.

What we claim and desire to protect by Letters Patent is:

1. A novel predictive modeling system for revenue optimization management with respect to an air cargo business comprising:
leveraging intrinsic co-clusters of airport origination and destination pairs (OD pairs) to construct dual predictive models for all OD pairs;
said revenue optimization including selection of an optimal route and bidding price that maximizes the revenue for said air cargo business overall at different time periods, said revenue optimization method meeting capacity constraints and benchmark revenues for both said OD pair and overall revenue;
said predictive modeling system being implemented by forecasting capacity, and processing data in an executive reporting module and a pricing strategy module.

2. The system defined in claim 1 wherein said forecasting capacity is based upon total available shipping capacity, booking information and predicted winning probability.

3. The system defined in claim 2 wherein said booking information in each instance includes variables selected from the group consisting of OD pair, date, piece, weight, volume, customer market, route and lead time.

4. The system defined in claim 1 wherein said executive reporting module predicts overall revenue, predicted revenue per OD pair, benchmark overall revenue, and benchmark revenue per OD pair over different time periods.

5. The system defined in claim 1 wherein said pricing strategy module balances multiple decision factors.

6. The system defined in claim 5 wherein said multiple decision factors are selected from the group consisting of, available routes, capacity, peak/off-peak season, customer market category, and market intelligence factors.

7. The system defined in claim 1 wherein said forecasting capacity is based upon total available shipping capacity, predicted winning probability and booking information in each instance including variables selected from the group consisting of OD pair, date, piece, weight, volume, customer market, route and lead time;
said executive reporting module predicting overall revenue, predicted revenue per OD pair, benchmark overall revenue, and benchmark revenue per OD pair over different time periods.
said pricing strategy module balances multiple decision factors selected from the group consisting of, available routes, capacity, peak/off-peak season, customer market category, and market intelligence factors;
said probabilistic framework simultaneously constructing dual predictive models that uncover co-clusters of originations and destinations that maximizes conditional probability of observing the responses from both a quotation stage and a decision stage, given the features and co-clusters, said probabilistic framework include the following objective function, used to determine the conditional probability of observing the data, that comprise two types of responses and vectors of parameters given the features xᵢⱼₖ and the mappings Φ_{R} and Φ_{C} by modeling bidding price using the linear regression model and concurrently modeling win rate using the linear regression and logistic regression model:
Σ_{i,j,k} {log p(y_{i,j,k}⁽¹⁾|x_{i,j,k}, β_{i,j}⁽¹⁾)+log p(y_{i,j,k}⁽²⁾|x_{i,j,k}, y_{i,j,k}⁽¹⁾, β_{i,j}⁽²⁾)}+Σₛ(Σ_{r,c} log μ_{i,j}^{(s)}p(ûᵣ, \hat{v}_{c}))+Σᵣ Σ_{Φ}_{_{R}}₍ᵤ_{ᵢ}_{)=û}_{ᵣ} log p^{(s)}(uᵢ|ûᵣ) p^{(s)}(β_{i,j}^{(s)}|uᵢ)+Σ_{c} Σ_{Φ}_{_{C}}₍ᵥ_{ⱼ}_{)=\hat{v}}_{_{c}} log p^{(s)}(vⱼ|\hat{v}_{c}) p^{(s)}(β_{i,j}^{(s)}|vⱼ)
where the first term is the log likelihood of the model to predict a bidding price based on cargo information x_{i,j,k}, and i, j, and k represent original i, destination j, and the kth cargo, a linear regression model can be used, and β_{i,j}⁽¹⁾ is the coefficient matrix to be estimated. The second term is the log likelihood of model to predict the win rate based on both cargo features and bidding price y_{i,j,k}⁽¹⁾, a logistic regression model can be used, β_{i,j}⁽²⁾ is the coefficient matrix to be estimated. The third term is the joint probability of the rth row and cth column cluster and imposes the assumption that the coefficient matrix of the two models share the same co-cluster membership, where μ_{i,j}^{(s)} is a normalized parameter such that p(ûᵣ, \hat{v}_{c}), is a meaningful probability distribution. The fourth term is the log likelihood of the probability given the ith origination, and the fifth term is the log likelihood of the probability given the jth origination.

8. A predictive modeling method for optimizing revenue management for the airline cargo business comprising:
said method constructing models for OD pairs with limited transactions and designed to share information between separated predictive analysis for a price and win rate modeling;
collecting data in a data storage center comprising a functional block that stores user input, system output, historical data, capacity information routing and marketing intelligence information;
historical information and a given OD pair from said data center is transmitted to a OD pair. Grouping Module which groups the OD pairs with extreme low transaction volume based upon distance and routing information;
certain data from said Grouping Module and data from said Booking Information are then transmitted to:
a.) a Predictive Modeling Module which is a functional block training predictive models, updating predictive models and generating an output comprising Predicted Bidding Price, Predicted Win Rate and Predicted Revenue while
b.) concurrently transmitting processed data from said Predictive Modeling Module and said Data Center to a Revenue Optimization Module being a functional block calculating revenue at different levels at different time periods and optimizing a decision for utilizing the predicted bidding price;
said Revenue Optimization Module output calculates a revenue calculation overall for cargo business at different time periods and also calculates revenue with respect to each OD pair at a different time period;
said Revenue Optimization Module determines if predicted overall revenue is greater than benchmark revenue;
if NO, said module identifies OD pairs with predicted revenue less than OD pair benchmark revenue;
if YES, data from identified OD pairs with predicted revenue less than OD pair benchmark revenue and data wherein predicted overall revenue is greater than benchmark revenue are collectively applied to a bidding price;
concurrently, data from said Revenue Optimization Module is transmitted to a Capacity Forecasting Module that forecasts capacity based upon total available capacity, booking information and predicted win rate, said data being transmitted via an Available Alternative Route to said Predictive Modeling Module.

9. The predictive modeling method for optimizing revenue management for the airline cargo business wherein an objective function:
Σ_{i,j,k} {log p(y_{i,j,k}⁽¹⁾|x_{i,j,k}, β_{i,j}⁽¹⁾)+log p(y_{i,j,k}⁽²⁾|x_{i,j,k}, y_{i,j,k}⁽¹⁾, β_{i,j}⁽²⁾)}+Σₛ(Σ_{r,c} log μ_{i,j}^{(s)}p(ûᵣ, \hat{v}_{c}))+Σᵣ Σ_{Φ}_{_{R}}₍ᵤ_{ᵢ}_{)=û}_{ᵣ} log p^{(s)}(uᵢ|ûᵣ) p^{(s)}(β_{i,j}^{(s)}|uᵢ)+Σ_{c} Σ_{Φ}_{_{C}}₍ᵥ_{ⱼ}_{)=\hat{v}}_{_{c}} log p^{(s)}(vⱼ|\hat{v}_{c}) p^{(s)}(β_{i,j}^{(s)}|vⱼ)
is used in a Predictive Modeling Module to predict bidding price, win rate and revenue (price×win rate) for incoming booking.
wherein the first term is the log likelihood of the model to predict the bidding price based on cargo information x_{i,j,k}, and i, j, and k represent original i, destination j, and the kth cargo, a linear regression model can be used, and β_{i,j}⁽¹⁾ is the coefficient matrix to be estimated. The second term is the log likelihood of model to predict the win rate based on both cargo features and bidding price y_{i,j,k}⁽¹⁾, a logistic regression model can be used, β_{i,j}⁽²⁾ is the coefficient matrix to be estimated.
The third term is the joint probability of the rth row and cth column cluster and imposes the assumption that the coefficient matrix of the two models share the same co-cluster membership, where μ_{i,j}^{(s)} is a normalized parameter such that p(ûᵣ, \hat{v}_{c}), is a meaningful probability distribution. The fourth term is the log likelihood of the probability given the ith origination, and the fifth term is the log likelihood of the probability given the jth origination.

10. The predictive modeling method for optimizing revenue management for the airline cargo business as defined in claim 8 wherein said historical data is historical cargo booking information associated with OD pair, corresponding bidding price and outcome.

11. The predictive modeling method for optimizing revenue management for the airline cargo business defined in claim 8, wherein said output from said Revenue Optimization Module is predicted overall revenue on a yearly, quarterly, monthly, weekly daily basis, predicted revenue per OD pair on a yearly, quarterly, monthly, weekly daily basis, benchmark overall revenue on a yearly, quarterly, monthly, weekly daily basis and benchmark revenue per OD pair on a yearly, quarterly, monthly, weekly daily basis.

12. A computer program product for a predictive modeling method for obtaining an optimal decision with respect to a cargo bidding price, the computer program product comprising a computer readable storage medium having program instructions embodied therewith, said program instructions executable by a microprocessor to cause the device, in a booking module, to collect booking information and store said booking information in a database;
assemble OD pair grouping module groups containing OD pairs with extreme low transaction volume based on distance and routing information, transmitting same to a predictive modeling module and;
in a predictive modeling module, employing said booking information and a trained model to simultaneously determine each OD pair's cluster membership, predicting a bidding price, win rate and revenue for incoming bookings;
using a revenue optimization module to obtain an output from said predictive modeling module, booking information at selected time period, historical data, capacity parameters, and market intelligence factors, and calculating various revenue parameters at different time horizon, such as overall revenue, per OD pair revenue, benchmark overall revenue and benchmark revenue per OD pair.
said output from revenue optimization module is obtained using a capacity forecasting module to forecast the capacity over a selected time period based on total available capacity, existing bookings and predicted win rate of incoming book and then determining the capacity availability of selected OD pairs for incoming booking;
returning data to said revenue optimization module if said capacity is not sufficient for a selected OD pair, in such event, all incoming booking associated with the OD pair is rejected;
if not rejected, said revenue optimization module compares whether predictive overall revenue exceeds the benchmark overall revenue in a selected time period;
if YES, said revenue optimization module determines that predictive overall revenue exceeds the benchmark overall revenue in a selected time period, in such event, recommendation is made to use predicted bidding price and customer selected route for all incoming bookings
alternatively, if NO, said revenue optimization module identifies OD pairs with predictive venue less than their corresponding benchmark revenue;
for booking with respect to large, medium and small market sectors, if a predicted price (P) is no less than a corresponding threshold E determined based on customer market sector and market intelligence factor, said program product recommends use of a predicted bidding price and route;
alternatively, said revenue optimization module determines whether and alternative route for said OD pairs is available.
if YES, said alternative route is used to route data to the predictive modeling module which performs the bidding price, win rate and revenue prediction given the updated information;
if NO, an incoming booking associated with the OD pair and selected route are rejected.

13. The computer program product defined in claim 12 wherein said different time horizon is overall revenue per OD pair, revenue, benchmark overall revenue and benchmark revenue per OD pair.

14. The computer program product defined in claim 12 wherein an objective function
Σ_{i,j,k} {log p(y_{i,j,k}⁽¹⁾|x_{i,j,k}, β_{i,j}⁽¹⁾)+log p(y_{i,j,k}⁽²⁾|x_{i,j,k}, y_{i,j,k}⁽¹⁾, β_{i,j}⁽²⁾)}+Σₛ(Σ_{r,c} log μ_{i,j}^{(s)}p(ûᵣ, \hat{v}_{c}))+Σᵣ Σ_{Φ}_{_{R}}₍ᵤ_{ᵢ}_{)=û}_{ᵣ} log p^{(s)}(uᵢ|ûᵣ) p^{(s)}(β_{i,j}^{(s)}|uᵢ)+Σ_{c} Σ_{Φ}_{_{C}}₍ᵥ_{ⱼ}_{)=\hat{v}}_{_{c}} log p^{(s)}(vⱼ|\hat{v}_{c}) p^{(s)}(β_{i,j}^{(s)}|vⱼ)
wherein the first term is the log likelihood of the model to predict the bidding price based on cargo information x_{i,j,k}, and i, j, and k represent original i, destination j, and the kth cargo, a linear regression model can be used, and β_{i,j}⁽¹⁾ is the coefficient matrix to be estimated. The second term is the log likelihood of model to predict the win rate based on both cargo features and bidding price y_{i,j,k}⁽¹⁾, a logistic regression model can be used, β_{i,j}⁽²⁾ is the coefficient matrix to be estimated. The third term is the joint probability of the rth row and cth column cluster and imposes the assumption that the coefficient matrix of the two models share the same co-cluster membership, where μ_{i,j}^{(s)} is a normalized parameter such that p(ûᵣ, \hat{v}_{c}), is a meaningful probability distribution. The fourth term is the log likelihood of the probability given the ith origination, and the fifth term is the log likelihood of the probability given the jth origination is used is used in a Predictive Modeling Module to predict bidding price, win rate and revenue (price×win rate) for an incoming booking.

15. The computer program product defined in claim 12 wherein said historical data is historical cargo booking information associated with OD pair, corresponding bidding price and outcome.

16. The computer program product defined in claim 12, wherein said output from said Revenue Optimization Module is predicted overall revenue on a yearly, quarterly, monthly, weekly daily basis, predicted revenue per OD pair on a yearly, quarterly, monthly, weekly daily basis, benchmark overall revenue on a yearly, quarterly, monthly, weekly daily basis and benchmark revenue per OD pair on a yearly, quarterly, monthly, weekly daily basis.

17. The computer program product defined in claim 12 wherein said forecasting capacity is based upon total available shipping capacity, booking information and predicted winning probability.

18. The computer program product defined in claim 12 wherein said booking information in each instance includes variables selected from the group consisting of OD pair, date, piece, weight, volume, customer market, route and lead time.

19. The computer program product defined in claim 12 wherein said executive reporting module predicts overall revenue, predicted revenue per OD pair, benchmark overall revenue, and benchmark revenue per OD pair over different time periods.

20. The computer program product defined in claim 12 wherein said multiple decision factors are selected from the group consisting of, available routes, capacity, peak/off-peak season, customer market category, and market intelligence factors.
